(19) United States
(12) Patent Application Publication
(10) Pub. No.: US 2025/0181404 A1
(43) Pub. Date: Jun. 5, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: KYOUHEI SUZUKI, TOKYO (JP)

(21) Appl. No.: 18/844,220

(22) PCT Filed: Feb. 22, 2023
(86) PCT No.: PCT/JP2023/006363

§ 371 Date: Sep. 5, 2024

(30) Foreign Application Priority Data
Mar. 16, 2022 (JP) 2022-041867

(51) Int. Cl. G06F 9/50

(52) U.S. Cl. CPC G06F 9/5027

(57) ABSTRACT

A robot (10) is an information processing apparatus, which is one of nodes in a network system (1) including a plurality of nodes. The robot (10) includes: an analysis unit (16b) that analyzes each of the possibility of securing resources shared by the nodes, the availability of each of nodes, and an optimization problem related to task execution; and a quorum configuration setting unit (16c) (corresponding to one example of “setting unit”) that sets a group of nodes participating in agreement formation in the network system (1) based on at least one of analysis results from the analysis unit (16b).

### FIELD

The present disclosure relates to an information processing apparatus, an information processing method, and a program.

### BACKGROUND

“Paxos”, “Raft”, and the like have been known as agreement algorithms for forming agreement between nodes in distributed computing of a network system including a plurality of nodes capable of communication.

“Paxos” and “Raft” have a concept called a quorum (e.g., see Non Patent Literature 1). The quorum is a concept obtained by generalizing decision by a majority, and includes the decision by a majority. Acceptors are collected into a group called a quorum as described above. The acceptors are nodes functioning as fault-tolerant “memories” in a Paxos protocol.

A client in the Paxos protocol seeks agreement from all acceptors belonging to the quorum. When all the acceptors agree, a requested action can be executed. These days, many agreement algorithms implemented by common database software in network systems implement the quorum.

### CITATION LIST

### Non Patent Literature

Non Patent Literature 1: [online], ETH zuerich, [Searched on Feb. 21, 2022], Internet <URL:https://disco.ethz.ch/courses/podc_allstars/lecture/chapter19.pdf>

### SUMMARY

### Technical Problem

The above-described conventional technique, however, has room for further improvement in order to further improve the availability of an agreement algorithm in a network system.

For example, it is assumed that the network system includes a plurality of robots capable of moving in actual space. When a plurality of robots capable of executing a somewhat advanced task shares resources, an agreement algorithm is essential since there is a risk of deadlock in a case where no agreement is formed between the robots for securement and release of the resources.

Note, however, that, when each of the robots can move, network communication necessary for forming agreement is not necessarily always stable. Particularly in wireless communication, connection may be unstable, or communication may be impossible at a specific place.

Note that, although a mechanism for preventing formation of erroneous agreement even in an environment with unstable communication is prepared in the agreement algorithm, such a mechanism is often implemented after being optimized for a common client server model environment in the above-described common database software.

Furthermore, when a movable robot is included, it is necessary to consider physical resources that cannot be assumed from the common client server model environment, such as a passage and an elevator for the robot to move.

Therefore, the present disclosure proposes an information processing apparatus, an information processing method, and a program capable of further improving the availability of an agreement algorithm in a network system.

### Solution to Problem

In order to solve the above problems, one aspect of an information processing apparatus according to the present disclosure is an information processing apparatus, which is one of nodes in a network system including a plurality of nodes, includes: an analysis unit that analyzes each of the possibility of securing resources shared by the nodes, the availability of each of nodes, and an optimization problem related to task execution; and a setting unit that sets a group of nodes participating in agreement formation in the network system based on at least one of analysis results from the analysis unit.

### BRIEF DESCRIPTION OF DRAWINGS

FIG. 1 is an outline explanatory diagram of an information processing method according to an embodiment of the present disclosure.

FIG. 2 illustrates a configuration example of a network system according to the embodiment of the present disclosure.

FIG. 3 is a block diagram illustrating a configuration example of a robot according to the embodiment of the present disclosure.

FIG. 4 is an explanatory diagram (part 1) of a quorum configuration.

FIG. 5 is an explanatory diagram (part 2) of the quorum configuration.

FIG. 6 illustrates the relation between possibility of securing resources and a weight.

FIG. 7 illustrates examples of a case of high possibility of securing resources.

FIG. 8 illustrates the relation between availability of each of nodes and a weight.

FIG. 9 illustrates examples of a case of high availability of each of nodes.

FIG. 10 illustrates an example of a case where a quorum configuration is selected from analysis results regarding an optimization problem related to task execution such that an objective function is maximized or minimized.

FIG. 11 is an explanatory diagram of analysis of an optimization problem in consideration of a task that has not been scheduled yet.

FIG. 12 is a flowchart illustrating a procedure of processing executed by a robot.

FIG. 13 illustrates a configuration example of a network system according to a variation.

FIG. 14 illustrates examples of a case of high availability of each of nodes in the network system according to the variation.

FIG. 15 is a hardware configuration diagram illustrating one example of a computer that implements the function of a robot.

### DESCRIPTION OF EMBODIMENTS

An embodiment of the present disclosure will be described in detail below with reference to the drawings. Note that, in the following embodiment, the same reference signs are attached to the same parts to omit duplicate description.

Furthermore, in the following description, an information processing apparatus according to the embodiment of the present disclosure corresponds to a robot 10 or a server device 100 included in a network system 1 to be described later.

Furthermore, in the following description, a plurality of components having substantially the same functional configuration may be distinguished by attaching hyphenated different numbers after the same reference signs. For example, a plurality of configurations having substantially the same functional configuration is distinguished as a robot 10-1, a robot 10-2, . . . , as necessary. Note, however, that, when it is unnecessary to particularly distinguish a plurality of components having substantially the same functional configuration from one another, only the same reference signs are attached. For example, when it is unnecessary to particularly distinguish the robot 10-1, the robot 10-2, . . . from one another, each of the robot 10-1, the robot 10-2, . . . is simply described as a robot 10.

Furthermore, in the following description, a quorum is implemented in an agreement algorithm in distributed computing of a network system.

Furthermore, in the following description, a “node” includes all elements that can participate in the quorum, such as each process of the robot 10, the server device 100, the robot 10, and the server device 100 or service on the internet.

Furthermore, the present disclosure will be described in accordance with the following item order.
1. Outline
2. Configuration of Network System
3. Configuration of Robot
4. Variation
4-1. Case Where Server Device Is Included
4-2. When Situation of Each of Nodes Changes
4-3. Other Variations
5. Hardware Configuration
6. Conclusion

### 1. Outline

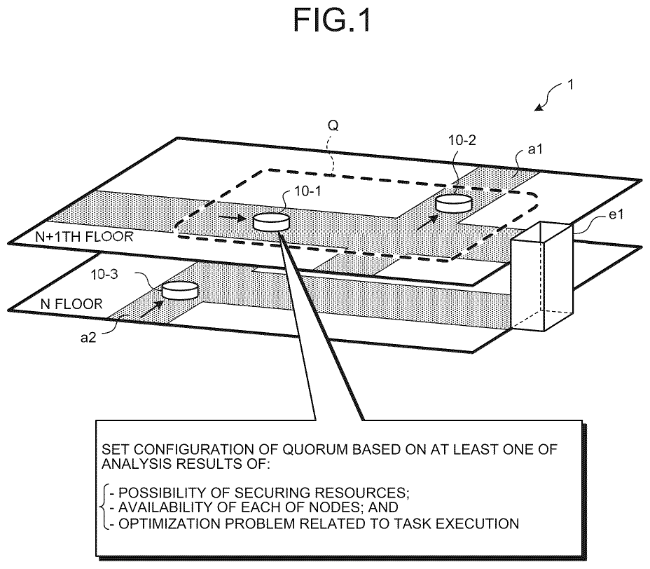

FIG. 1 is an outline explanatory diagram of an information processing method according to the embodiment of the present disclosure. When a network system includes a plurality of robots capable of moving in actual space, it is necessary to consider various factors in optimizing implementation of a quorum. The various factors include distribution and mutual exclusion of physical resources shared by the robots, such as a passage and an elevator, and robot communication quality that tends to be unstable due to the movability.

Specifically, as illustrated in FIG. 1, in the embodiment of the present disclosure, a case is assumed where the network system 1 includes, as nodes, a plurality of robots 10-1, 10-2, 10-3, . . . that can move in actual space.

The robots 10 are scattered in a plurality of floors (see “Nth floor” and “N+1th floor” in figure) in one building. The robots 10 execute tasks of the robots 10 themselves while distributing and mutually excluding various resources including physical resources such as passages a1 and a2 and an elevator e1. That is, at least one of the robots 10 can also move between floors via the elevator e1.

In the network system 1 as described above, in optimizing implementation of a quorum, it is necessary to consider distribution and mutual exclusion of physical resources such as the passages a1 and a2 and the elevator e1 in addition to logical resources such as a database and data in a memory, which are shared by the robots 10. Furthermore, it is also necessary to consider communication quality between robots 10 separated by a floor.

Therefore, in the information processing method according to the embodiment of the present disclosure, as illustrated in FIG. 1, each of the robots 10 that execute a task analyzes the possibility of securing resources, the availability of each of nodes, and an optimization problem related to task execution, and sets a configuration of a quorum Q based on at least one of the analysis results.

In one example, for example, the robot 10-3 frequently moves between floors via the elevator e1. Then, in configuring a quorum regarding task execution of the robot 10-1, the robot 10-1 determines the robot 10-3 as having a low availability since the robot 10-3 frequently moves in an environment where communication where communication is easily disrupted, and lowers the weight of the robot 10-3.

As a result, the robot 10-1 sets a configuration of the quorum Q including the robot 10-1 and the robot 10-2, for example.

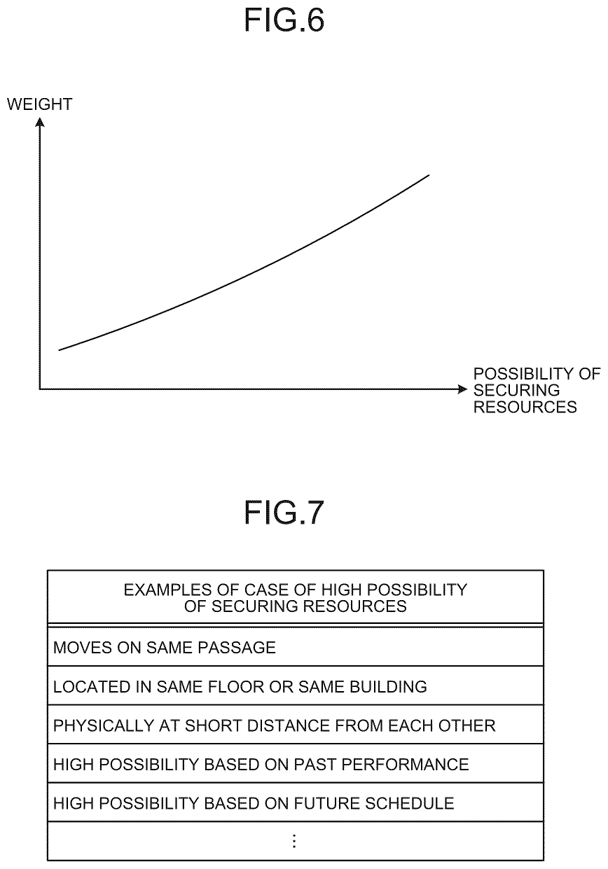

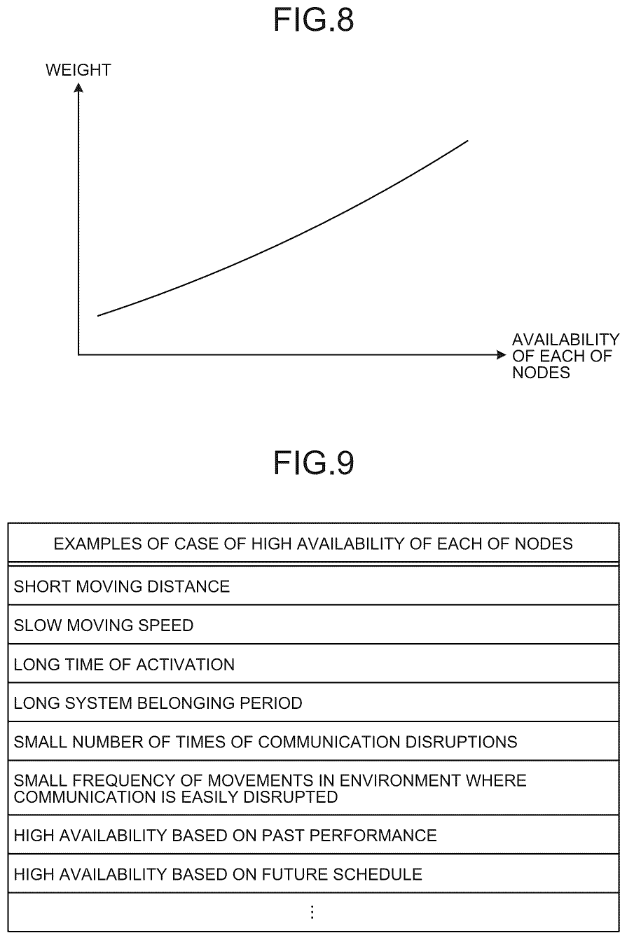

This can further improve the availability of an agreement algorithm in the network system 1 including a moving object as a node. A specific example of analysis processing regarding the possibility of securing resources will be described later with reference to FIGS. 6 and 7. Furthermore, a specific example of analysis processing regarding the availability of each of nodes will be described later with reference to FIGS. 8 and 9.

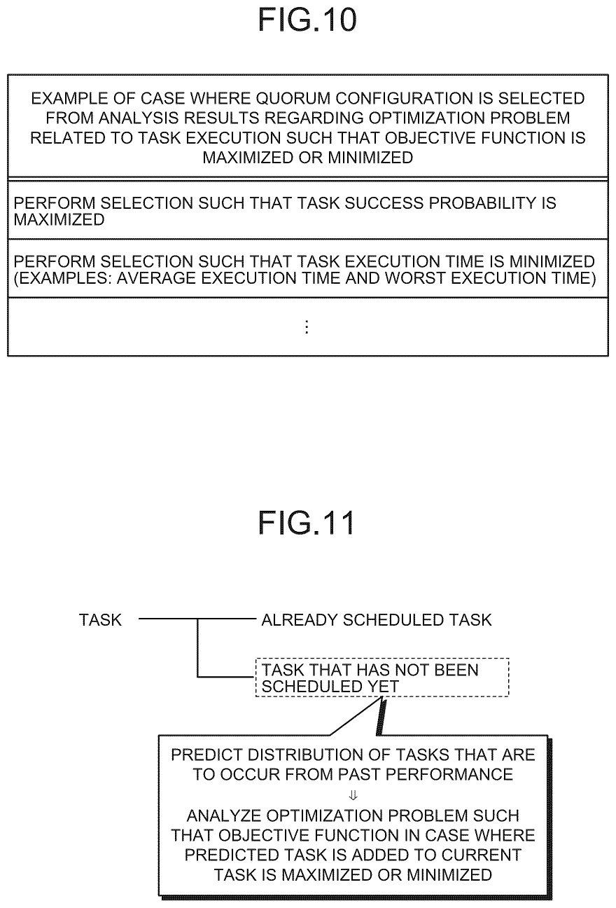

Furthermore, a specific example of analysis processing regarding the optimization problem related to task execution will be described later with reference to FIGS. 10 and 11. Note that, schematically speaking, in analysis processing regarding the optimization problem related to task execution, a robot 10 selects a quorum configuration such that an objective function related to the task execution is maximized or minimized.

A configuration example of the network system 1 to which the information processing method according to the embodiment of the present disclosure is applied will be more specifically described below.

### 2. Configuration of Network System

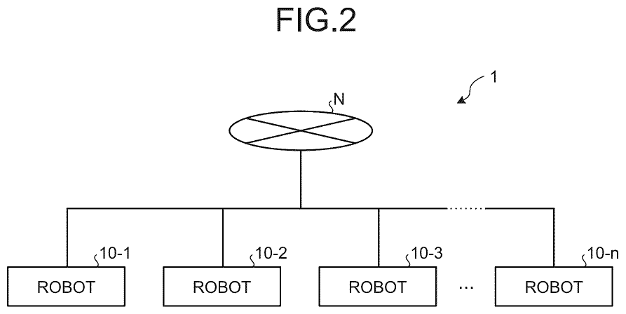

FIG. 2 illustrates a configuration example of the network system 1 according to the embodiment of the present disclosure. As illustrated in FIG. 2, the network system 1 includes a plurality of robots 10 of robots 10-1 to 10-n (n is natural number).

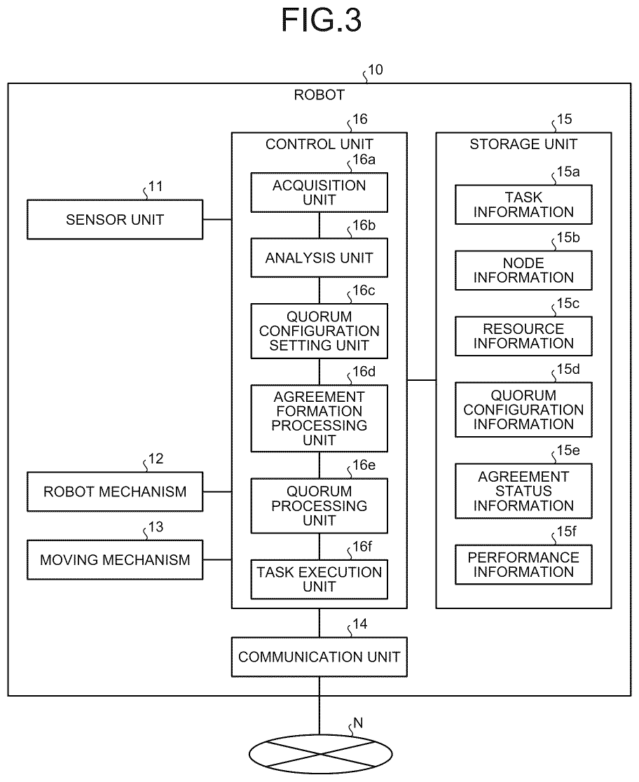

The robots 10 include a moving mechanism 13 (see FIG. 3), and can move at least autonomously or heteronomously. Furthermore, the robots 10 execute tasks allocated thereto based on task information 15a (see FIG. 3) to be described later.

Furthermore, the robots 10 can wirelessly communicate with one another via a network N or directly. The network N includes, for example, an intranet, the Internet, a mobile phone network, and a short-distance wireless communication network.

Note that, since each of the robots 10 moves in the network system 1, it is assumed that communication between the robots 10 is not always stable.

### 3. Configuration of Robot

Next, FIG. 3 is a block diagram illustrating a configuration example of a robot 10 according to the embodiment of the present disclosure. Note that FIG. 3 illustrates only components necessary for describing the features of the embodiment of the present disclosure, and descriptions of common components are omitted.

In other words, components in FIG. 3 are functional and conceptual, and are not necessarily required to be physically configured as illustrated. For example, the specific form of distribution/integration of each block is not limited to the illustrated one, and all or a part of the block can be configured in a functionally or physically distributed/integrated manner in any unit in accordance with various loads and use situations.

Furthermore, in description with reference to FIG. 3, descriptions of the already described components may be simplified or omitted.

As illustrated in FIG. 3, the robot 10 includes a sensor unit 11, a robot mechanism 12, the moving mechanism 13, a communication unit 14, a storage unit 15, and a control unit 16.

The sensor unit 11 is configured by a group of various sensors mounted on the robot 10. The sensor unit 11 senses a situation inside and outside the robot 10. The sensor unit 11 includes, for example, a camera, a global positioning system (GPS) sensor, and an inertial sensor.

The robot mechanism 12 includes various mechanisms used for the robot 10 to execute a task. The robot mechanism 12 includes, for example, a manipulator. The moving mechanism 13 is used for the robot 10 to move. The robot mechanism 12 and the moving mechanism 13 are controlled by the control unit 16 at the time of task execution in accordance with a task executed by the robot 10.

The communication unit 14 is implemented by, for example, a wireless communication module. The communication unit 14 is directly and wirelessly connected to the above-described network N or another robot 10. The communication unit 14 transmits and receives information to and from the other robot 10.

The storage unit 15 is implemented by, for example, a semiconductor memory element, such as a random access memory (RAM), a read only memory (ROM), and a flash memory, or a storage device, such as a hard disk and an optical disk. In an example in FIG. 3, the storage unit 15 stores the task information 15a, node information 15b, resource information 15c, quorum configuration information 15d, agreement status information 15e, and performance information 15f.

The task information 15a relates to a task executed by the robot 10. The task information 15a includes the execution date and time, execution position, and execution content of the task. The node information 15b relates to each of nodes included in the network system 1. The node information 15b includes information on an attribute of each of nodes.

The resource information 15c relates to each resource included in the network system 1 and shared by robots 10. The node information 15b and the resource information 15c are dynamically updated in accordance with the performance of task execution of the robot 10. For example, the robot 10 updates the current position of the host node included in the node information 15b and information on resources occupied or released by the host node included in the resource information 15c in accordance with the performance of task execution.

The quorum configuration information 15d relates to a quorum configuration being set by the robot 10. The quorum configuration information 15d includes a network address of each of nodes belonging to a quorum being set.

The agreement status information 15e includes a real-time agreement status in quorum processing. The performance information 15f relates to performance of the task executed by the robot 10. In addition to the performance of task execution, the performance information 15f includes whether or not agreement has been formed in a quorum in the task execution and performance of communication with another node.

Note that various pieces of information 15a to 15f stored in the storage unit 15 and each piece of data included therein can be shared between nodes by forming agreement regarding a write request to each of nodes belonging to a set quorum or a read request from one of the nodes and executing the request.

The control unit 16 is a controller, and is implemented by, for example, a central processing unit (CPU) and a micro processing unit (MPU) executing a program (not illustrated) according to the embodiment of the present disclosure stored in the storage unit 15 using a RAM as a work area. Furthermore, the control unit 16 can be implemented by an integrated circuit such as an application specific integrated circuit (ASIC) and a field programmable gate array (FPGA).

The control unit 16 includes an acquisition unit 16a, an analysis unit 16b, a quorum configuration setting unit 16c, an agreement formation processing unit 16d, a quorum processing unit 16e, and a task execution unit 16f. The control unit 16 implements or executes functions and actions of information processing to be described below.

The acquisition unit 16a acquires various pieces of sensor data output from the sensor unit 11. Furthermore, the acquisition unit 16a acquires information on a task to be executed next by the robot 10 from the task information 15a.

The analysis unit 16b analyzes each of the possibility of securing resources in the network system 1, the availability of each of nodes, and an optimization problem related to task execution in accordance with the task to be executed next by the robot 10.

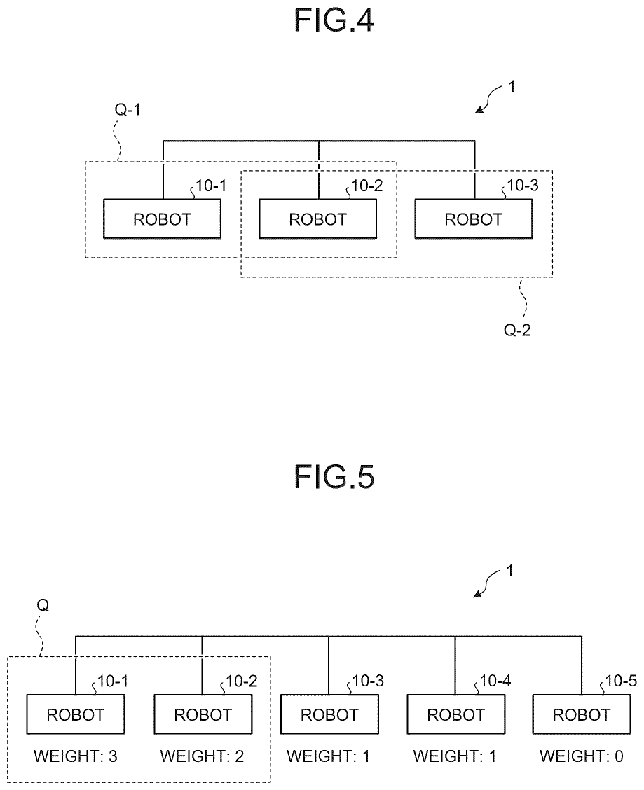

The quorum configuration setting unit 16c sets a quorum configuration based on an analysis result from the analysis unit 16b. Here, an example of the quorum configuration set by the quorum configuration setting unit 16c will be described with reference to FIGS. 4 and 5. FIG. 4 is an explanatory diagram (part 1) of the quorum configuration. Furthermore, FIG. 5 is an explanatory diagram (part 2) of the quorum configuration.

As illustrated in FIG. 4, it is assumed that the network system 1 includes three robots 10 of robots 10-1 to 10-3. In such a case, the quorum configuration setting unit 16c typically sets the quorum Q such that a quorum satisfies a majority as illustrated in FIG. 4.

That is, in an example in FIG. 4, the quorum configuration setting unit 16c sets a quorum Q-1 including the robots 10-1 and 10-2. Alternatively, the quorum configuration setting unit 16c sets a quorum Q-2 including the robots 10-2 and 10-3. Note that, in this case, the quorum configuration setting unit 16c sets a quorum Q such that any quorum Q includes a common node (here, robot 10-2).

Furthermore, as illustrated in FIG. 5, the quorum configuration setting unit 16c sets a quorum Q in accordance with a weight given to each of the robots 10 by the analysis unit 16b. Note that, in FIG. 5, for convenience of description, each weight is represented by an integer. As illustrated in FIG. 5, it is assumed that the network system 1 includes five robots 10 of robots 10-1 to 10-5.

In such a case, according to the example in FIG. 4, at least three robots 10 belong to one quorum Q. When the total of weights of the robots 10 exceeds half of the total of the entire weights, the quorum configuration setting unit 16c can set a quorum Q by a corresponding robot 10.

In an example in FIG. 5, the quorum configuration setting unit 16c can set a quorum Q by two robots 10-1 and 10-2.

The weight of each of the robots 10 is given by analysis processing executed by the analysis unit 16b. Here, the analysis processing executed by the analysis unit 16b will be described with reference to FIGS. 6 to 11. FIG. 6 illustrates the relation between the possibility of securing resources and a weight. Furthermore, FIG. 7 illustrates examples of a case of high possibility of securing resources.

Furthermore, FIG. 8 illustrates the relation between the availability of each of nodes and a weight. Furthermore, FIG. 9 illustrates examples of a case of high availability of each of nodes. Furthermore, FIG. 10 illustrates an example of a case where a quorum configuration is selected from analysis results regarding an optimization problem related to task execution such that an objective function is maximized or minimized. Furthermore, FIG. 11 is an explanatory diagram of analysis of an optimization problem in consideration of a task that has not been scheduled yet.

First, the analysis unit 16b executes analysis processing (first analysis processing) related to the possibility of securing resources. As illustrated in FIG. 6, the analysis unit 16b weights each of the robots 10 such that the weight increases as the possibility of securing resources increases. The possibility of securing resources is possibility that each of nodes secures resources.

As illustrated in FIG. 7, examples of a case of high possibility of securing resources include a case where each of the robots 10 moves on the same passage, a case where each of the robots 10 is located in the same floor or the same building, a case where the robots 10 are physically at a short distance from one another, a case of high possibility based on past performance, and a case of high possibility based on a future schedule. The analysis unit 16b executes the first analysis processing based on the task information 15a, the node information 15b, the resource information 15c, the performance information 15f, and the like stored in the storage unit 15 and shared in the network system 1 as described above, and weights each of the robots 10.

Furthermore, the analysis unit 16b executes analysis processing (second analysis processing) related to the availability of each of nodes. As illustrated in FIG. 8, the analysis unit 16b weights each of the robots 10 such that the weight increases as the availability of each of nodes increases.

As illustrated in FIG. 9, examples of the case of high availability of each of nodes include a case of a short moving distance, a case of a slow moving speed, a case of a long time of activation, a case of a long system belonging period, a case of a small number of times of communication disruptions, a case of a small frequency of movements in an environment where communication is easily disrupted, a case of high availability based on past performance, and a case of high availability based on a future schedule.

Therefore, for example, the analysis unit 16b lowers the weights of a robot 10 that is activated only for a specific time, a recently added robot 10, a robot 10 having an increased maximum speed, a robot 10 in which communication is easily disrupted, and a robot 10 that frequently uses the elevator e1. Note that the moving distance, the moving speed, the activation time, the system belonging period, and information on communication disruption relate to an attribute of each of nodes.

As in a case of the possibility of securing resources, the analysis unit 16b executes the second analysis processing based on the task information 15a, the node information 15b, the resource information 15c, the performance information 15f, and the like stored in the storage unit 15 and shared in the network system 1 as described above, and weights each of the robots 10.

Furthermore, the analysis unit 16b executes analysis processing (third analysis processing) regarding an optimization problem related to task execution. In such analysis processing, the analysis unit 16b executes simulation regarding various quorum configurations, failure occurrence, and the like. Then, the analysis unit 16b selects a quorum configuration from the simulation results such that an objective function is maximized or minimized in relation to the task execution.

As illustrated in FIG. 10, examples of the case of performing selection such that an objective function is maximized include a case of performing selection such that task success probability is maximized. In contrast, examples of the case of performing selection such that the objective function is minimized include a case of performing selection such that a task execution time is minimized. The task execution time includes an average execution time and a worst execution time in addition to a simple execution time.

Note that one or both of an analysis result of the above-described first analysis processing and an analysis result of the second analysis processing may be appropriately considered for the third analysis processing.

Furthermore, as illustrated in FIG. 11, in the third analysis processing, the “task” includes a “task that has not been scheduled yet” in addition to a “already scheduled task”. As illustrated in FIG. 11, for the “task that has not been scheduled yet”, the analysis unit 16b predicts distribution of tasks that are to occur from past performance. Then, the analysis unit 16b analyzes an optimization problem such that an objective function in a case where the predicted task is added to the current task is maximized or minimized.

This enables the analysis unit 16b to select a quorum such that the objective function is maximized or minimized including the “task that has not been scheduled yet”.

The description returns to FIG. 3. The agreement formation processing unit 16d executes agreement formation processing based on the set quorum configuration. The agreement formation processing unit 16d generates an agreement request in accordance with a task, and transmits the agreement request to each of nodes belonging to the set quorum configuration via the communication unit 14. Furthermore, the agreement formation processing unit 16d receives an agreement response to the transmitted agreement request from each of nodes via the communication unit 14. Furthermore, the agreement formation processing unit 16d updates the agreement status information 15e in accordance with the received agreement response.

The quorum processing unit 16e executes quorum processing based on the agreement status information 15e. Specifically, the quorum processing unit 16e determines whether or not agreement has been formed based on the agreement status information 15e. Furthermore, when agreement is successfully formed, the quorum processing unit 16e causes the task execution unit 16f to execute the task based on the agreement.

Furthermore, when agreement has failed to be formed, the quorum processing unit 16e does not cause the task execution unit 16f to execute the corresponding task. Furthermore, the quorum processing unit 16e updates the performance information 15f in accordance with performance related to whether or not agreement has been formed.

Note that the agreement formation processing unit 16d and the quorum processing unit 16e can also execute the agreement formation processing and the quorum processing for the setting itself of the quorum configuration performed by the quorum configuration setting unit 16c.

In such a case, the agreement formation processing unit 16d executes agreement formation processing related to the setting of the quorum configuration. The agreement formation processing unit 16d generates an agreement request for a node that is a candidate for belonging to a desired quorum configuration of the quorum configuration setting unit 16c, and transmits the agreement request to each of corresponding nodes via the communication unit 14. Furthermore, the agreement formation processing unit 16d receives an agreement response to the transmitted agreement request from each of nodes via the communication unit 14. Furthermore, the agreement formation processing unit 16d updates the agreement status information 15e in accordance with the received agreement response.

The quorum processing unit 16e determines whether or not agreement has been formed based on the agreement status information 15e. Furthermore, when agreement is successfully formed, the quorum processing unit 16e causes the quorum configuration setting unit 16c to set a desired quorum configuration.

Furthermore, when agreement has failed to be formed, the quorum processing unit 16e does not cause the quorum configuration setting unit 16c to set a desired quorum configuration. In such a case, the quorum configuration setting unit 16c retries to set a new quorum configuration. Furthermore, the quorum processing unit 16e updates the performance information 15f in accordance with performance related to whether or not agreement has been formed.

In relation to task execution, when the quorum processing unit 16e determines that agreement has successfully formed, the task execution unit 16f executes the corresponding task. In task execution, the task execution unit 16f controls the robot mechanism 12 and the moving mechanism 13 in accordance with the task. Furthermore, the task execution unit 16f updates the performance information 15f in accordance with performance related to task execution.

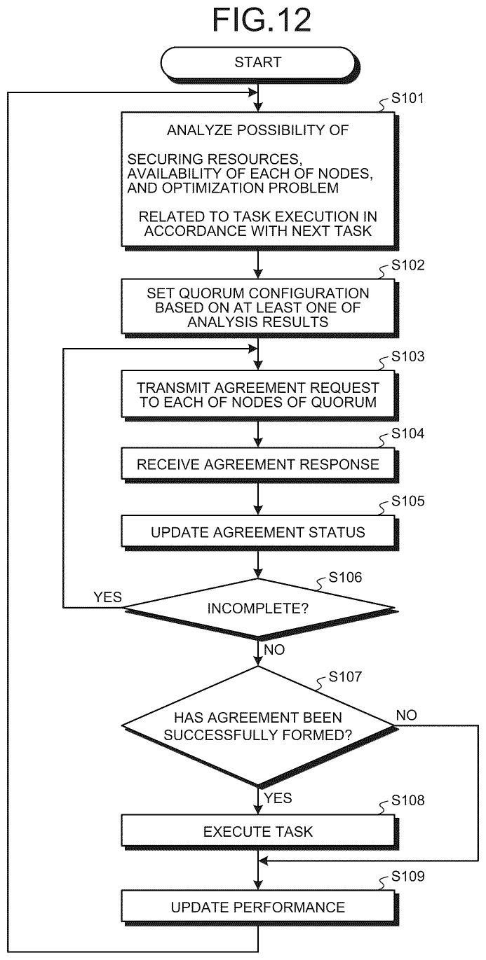

Next, a procedure of processing executed by a robot 10 will be described with reference to FIG. 12. FIG. 12 is a flowchart illustrating the procedure of processing executed by the robot 10.

As illustrated in FIG. 12, in the network system 1, the analysis unit 16b analyzes the possibility of securing resources, the availability of each of nodes, and an optimization problem related to task execution in accordance with a task to be executed next (Step S101).

Then, the quorum configuration setting unit 16c sets a quorum configuration based on at least one of the analysis results from the analysis unit 16b (Step S102).

Then, the agreement formation processing unit 16d transmits an agreement request to each of nodes of the quorum (Step S103). Furthermore, the agreement formation processing unit 16d receives an agreement response to the transmitted agreement request (Step S104). Furthermore, the agreement formation processing unit 16d updates the agreement status information 15e based on the received agreement response (Step S105).

Then, the agreement formation processing unit 16d determines whether or not reception of the agreement request and the agreement response is incomplete (Step S106). When the reception is incomplete (Step S106, Yes), the processing from Step S103 is repeated.

When the reception is not incomplete (Step S106, No), the quorum processing unit 16e determines whether or not agreement has been successfully formed (Step S107). When agreement has been successfully formed (Step S107, Yes), the task execution unit 16f executes a corresponding task (Step S108).

When agreement has failed to be formed (Step S107, No), the task execution unit 16f shifts to Step S109 without executing the corresponding task.

In Step S109, the quorum processing unit 16e and the task execution unit 16f update performance in the quorum processing or the task execution processing (Step S109). Then, the processing from Step S101 is repeated.

### 4. Variation

By the way, the above-described embodiment of the present disclosure can include some variations.

### <4-1. Case Where Server Device Is Included>

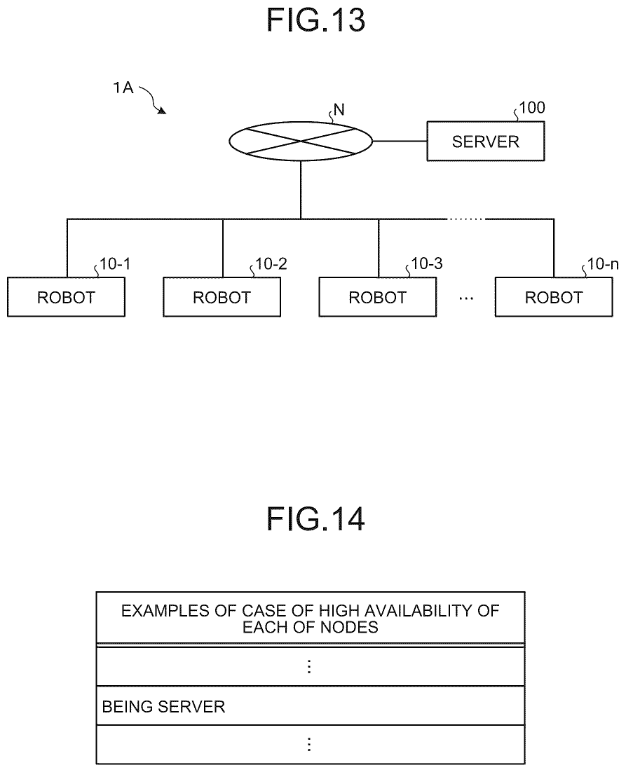

FIG. 13 illustrates a configuration example of a network system 1A according to a variation. Furthermore, FIG. 14 illustrates examples of a case of high availability of each of nodes in the network system 1A according to the variation.

As illustrated in FIG. 13, the network system 1A according to the variation further includes the server device 100 in contrast to the network system 1 in FIG. 2. The server device 100 is, for example, a computer that functions as an integrated server, a database server, a transaction server, an application server, and a file server in the network system 1A, and may be one of nodes. The server device 100 is connected to the network N in a wired or wireless manner.

When the server device 100 is one of nodes, examples of the case of high availability of each of nodes in FIG. 9 can further include being a server as illustrated in FIG. 14.

### <4-2. When Situation of Each of Nodes Changes>

Furthermore, when a situation of each of nodes changes, the analysis unit 16b may cause the quorum configuration setting unit 16c to dynamically change the quorum configuration in accordance with the change. In such a case, the analysis unit 16b detects a change in the situation of each of nodes based on, for example, sensing data of the sensor unit 11 acquired by the acquisition unit 16a and the node information 15b and the resource information 15c dynamically updated and shared between nodes.

Then, for example, when an operating state or a communication situation of one of nodes belonging to a quorum configuration being set deteriorates, the analysis unit 16b causes the quorum configuration setting unit 16c to change the quorum configuration by lowering the weight of the node. This can contribute to securing the availability of an agreement algorithm while responding to a dynamic change in the situation.

### <4-3. Other Variations>

Furthermore, the quorum configuration in FIGS. 4 and 5 is merely one example, and there are various other forms of the quorum configuration. For example, a subgroup based on the attribute of each of nodes may be created in a quorum. The created subgroup may be ordered, and an algorithm for “grid quorum systems” (e.g., see Non Patent Literature 1) may be applied.

Furthermore, although, in the above-described embodiment of the present disclosure, an example has been described in which quorums are implemented in agreement algorithms of the network systems 1 and 1A, a rule of agreement formation in a group of nodes participating in the agreement formation and the like are not limited. Therefore, the agreement algorithm may include an algorithm derived from a quorum and an algorithm other than a quorum, which substitutes the quorum.

Furthermore, among pieces of processing described in the above-described embodiment of the present disclosure, all or a part of processing described as being performed automatically can be performed manually, or all or a part of processing described as being performed manually can be performed automatically by a known method. In addition, the processing procedures, the specific names, and information including various pieces of data and parameters in the above-described document and drawings can be optionally changed unless otherwise specified. For example, various pieces of information in each figure are not limited to the illustrated information.

Furthermore, each component of each illustrated device is functional and conceptual, and does not necessarily need to be physically configured as illustrated. That is, the specific form of distribution/integration of each device is not limited to the illustrated one, and all or part of the device can be configured in a functionally or physically distributed/integrated manner in any unit in accordance with various loads and use situations.

Furthermore, the above-described embodiment of the present disclosure can be appropriately combined in a region where the processing contents do not contradict each other. Furthermore, the order of steps in the sequence diagrams or the flowcharts of the embodiment can be appropriately changed.

### 5. Hardware Configuration

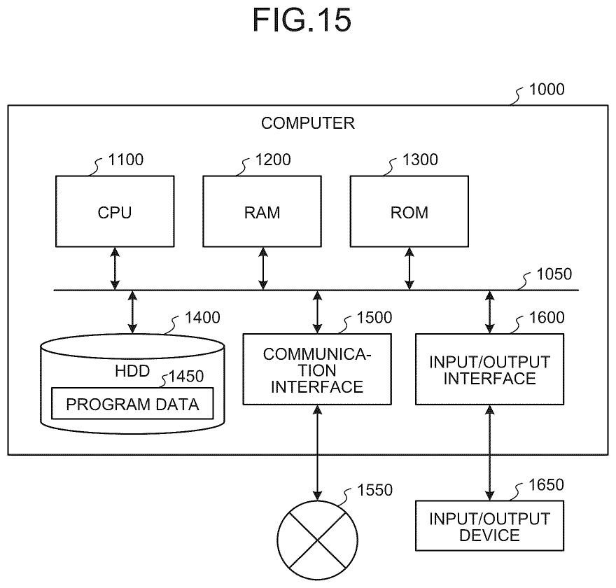

Furthermore, each of nodes such as the robots 10 and the server device 100 according to the above-described embodiment of the present disclosure is implemented by, for example, a computer 1000 having a configuration as illustrated in FIG. 15. A robot 10 will be described in an example. FIG. 15 is a hardware configuration diagram illustrating one example of the computer 1000 that implements the function of the robot 10. The computer 1000 includes a CPU 1100, a RAM 1200, a ROM 1300, a hard disk drive (HDD) 1400, a communication interface 1500, and an input/output interface 1600. Units of the computer 1000 are connected by a bus 1050.

The CPU 1100 operates based on a program stored in the ROM 1300 or the HDD 1400, and controls each of the units. For example, the CPU 1100 develops the program stored in the ROM 1300 or the HDD 1400 on the RAM 1200, and executes processing corresponding to various programs.

The ROM 1300 stores a boot program such as a basic input output system (BIOS) executed by the CPU 1100 at the time when the computer 1000 is activated, a program depending on the hardware of the computer 1000, and the like.

The HDD 1400 is a computer-readable recording medium that non-transiently records a program executed by the CPU 1100, data used by the program, and the like. Specifically, the HDD 1400 is a recording medium that records a program according to the embodiment of the present disclosure. The program is one example of program data 1450.

The communication interface 1500 connects the computer 1000 with an external network 1550 (e.g., network N). For example, the CPU 1100 receives data from another piece of equipment, and transmits data generated by the CPU 1100 to the other piece of equipment via the communication interface 1500.

The input/output interface 1600 connects an input/output device 1650 with the computer 1000. For example, the CPU 1100 receives data from an input device such as a keyboard and a mouse via the input/output interface 1600. Furthermore, the CPU 1100 transmits data to an output device such as a display, a speaker, and a printer via the input/output interface 1600. Furthermore, the input/output interface 1600 may function as a medium interface that reads a program and the like recorded in a predetermined recording medium. The medium includes, for example, an optical recording medium such as a digital versatile disc (DVD) and a phase change rewritable disk (PD), a magneto-optical recording medium such as a magneto-optical disk (MO), a tape medium, a magnetic recording medium, and a semiconductor memory.

For example, when the computer 1000 functions as the robot 10 according to the embodiment of the present disclosure, the CPU 1100 of the computer 1000 implements the function of the control unit 16 by executing a program loaded on the RAM 1200. Furthermore, the HDD 1400 stores a program according to the present disclosure and data in the storage unit 15. Note that the CPU 1100 reads the program data 1450 from the HDD 1400 and executes the program data 1450. In another example, the CPU 1100 may acquire these programs from another device via the external network 1550.

### 6. Conclusion

As described above, according to the embodiment of the present disclosure, a robot 10 (corresponding to one example of “information processing apparatus”), which is one of nodes in the network system 1 including a plurality of nodes, includes: the analysis unit 16b that analyzes each of the possibility of securing resources shared by the nodes, the availability of each of nodes, and an optimization problem related to task execution; and a quorum configuration setting unit 16c (corresponding to one example of “setting unit”) that sets a group of nodes participating in agreement formation in the network system 1 based on at least one of analysis results from the analysis unit 16b. This can further improve the availability of an agreement algorithm in the network system 1.

Although the embodiment of the present disclosure has been described above, the technical scope of the present disclosure is not limited to the above-described embodiment as it is, and various modifications can be made without departing from the gist of the present disclosure. Furthermore, components of different embodiments and variations may be appropriately combined.

Furthermore, the effects in the embodiment described in the present specification are merely examples and not limitations. Other effects may be exhibited.

Note that the present technology can also have the configurations as follows.

(1)

An information processing apparatus, which is one of nodes in a network system including a plurality of the nodes, comprising:
an analysis unit that analyzes each of possibility of securing a resource shared by nodes, availability of each of the nodes, and an optimization problem related to task execution; and
a setting unit that sets a group of nodes participating in agreement formation in the network system based on at least one of analysis results from the analysis unit.
   (2)

The information processing apparatus according to (1), being movable.

(3)

The information processing apparatus according to (2),
wherein the analysis unit
analyzes the possibility of securing a resource based on at least one of a movement path, a position, a distance, past performance, and a future schedule.
   (4)

The information processing apparatus according to (2) or (3),
wherein the analysis unit
analyzes the availability of each of the nodes based on at least one of information on an attribute of each of the nodes, past performance, and a future schedule.
   (5)

The information processing apparatus according to (4),
wherein the information on an attribute of each of the nodes
includes at least one of a moving distance of each of the nodes, a moving speed, an activation time, a system belonging period, and information on communication disruption.
   (6)

The information processing apparatus according to any one of (1) to (5),
wherein the analysis unit
analyzes the optimization problem related to task execution by executing simulation regarding configurations of a plurality of groups or failure occurrence.
   (7)

The information processing apparatus according to (6),
wherein the analysis unit
selects a group from the configurations of a plurality of groups based on a result of the simulation such that an objective function related to the task execution is maximized or minimized.
   (8)

The information processing apparatus according to (7),
wherein the analysis unit
selects the group such that task success probability is maximized.
   (9)

The information processing apparatus according to (7) or (8),
wherein the analysis unit
selects the group such that task execution time is minimized.
   (10)

The information processing apparatus according to (7), (8), or (9),
wherein the analysis unit
analyzes the optimization problem related to task execution by adding a task that has not been scheduled yet to an already scheduled task.
   (11)

The information processing apparatus according to (10),
wherein the analysis unit
predicts distribution of tasks that are to occur in future from past performance, and analyzes the optimization problem related to task execution such that the objective function in a case where a predicted task is added to the already scheduled task is maximized or minimized.
   (12)

The information processing apparatus according to any one of (1) to (11),
wherein the setting unit
sets the group based on a quorum.
   (13)

The information processing apparatus according to any one of (1) to (12), being a robot.

(14)

An information processing method executed by an information processing apparatus, which is one of nodes in a network system including a plurality of the nodes, comprising:
analyzing each of possibility of securing a resource shared by nodes, availability of each of the nodes, and an optimization problem related to task execution; and
setting a group of nodes participating in agreement formation in the network system based on at least one of analysis results in the analyzing.
   (15)

A program causing a computer, which is one of nodes in a network system including a plurality of the nodes, to:
analyze each of possibility of securing a resource shared by nodes, availability of each of the nodes, and an optimization problem related to task execution; and
set a group of nodes participating in agreement formation in the network system based on at least one of analysis results in the analyzing.

### REFERENCE SIGNS LIST

1 NETWORK SYSTEM
10 ROBOT
11 SENSOR UNIT
12 ROBOT MECHANISM
13 MOVING MECHANISM
14 COMMUNICATION UNIT
15 STORAGE UNIT
15a TASK INFORMATION
15b NODE INFORMATION
15c RESOURCE INFORMATION
15d QUORUM CONFIGURATION INFORMATION
15e AGREEMENT STATUS INFORMATION
15f PERFORMANCE INFORMATION
16 CONTROL UNIT
16a ACQUISITION UNIT
16b ANALYSIS UNIT
16c QUORUM CONFIGURATION SETTING UNIT
16d AGREEMENT FORMATION PROCESSING UNIT
16e QUORUM PROCESSING UNIT
16f TASK EXECUTION UNIT
100 SERVER DEVICE

1. An information processing apparatus, which is one of nodes in a network system including a plurality of the nodes, comprising:
an analysis unit that analyzes each of possibility of securing a resource shared by nodes, availability of each of the nodes, and an optimization problem related to task execution; and
a setting unit that sets a group of nodes participating in agreement formation in the network system based on at least one of analysis results from the analysis unit.

2. The information processing apparatus according to claim 1, being movable.

3. The information processing apparatus according to claim 2,
wherein the analysis unit
analyzes the possibility of securing a resource based on at least one of a movement path, a position, a distance, past performance, and a future schedule.

4. The information processing apparatus according to claim 2,
wherein the analysis unit
analyzes the availability of each of the nodes based on at least one of information on an attribute of each of the nodes, past performance, and a future schedule.

5. The information processing apparatus according to claim 4,
wherein the information on an attribute of each of the nodes
includes at least one of a moving distance of each of the nodes, a moving speed, an activation time, a system belonging period, and information on communication disruption.

6. The information processing apparatus according to claim 1,
wherein the analysis unit
analyzes the optimization problem related to task execution by executing simulation regarding configurations of a plurality of groups or failure occurrence.

7. The information processing apparatus according to claim 6,
wherein the analysis unit
selects a group from the configurations of a plurality of groups based on a result of the simulation such that an objective function related to the task execution is maximized or minimized.

8. The information processing apparatus according to claim 7,
wherein the analysis unit
selects the group such that task success probability is maximized.

9. The information processing apparatus according to claim 7,
wherein the analysis unit
selects the group such that task execution time is minimized.

10. The information processing apparatus according to claim 7,
wherein the analysis unit
analyzes the optimization problem related to task execution by adding a task that has not been scheduled yet to an already scheduled task.

11. The information processing apparatus according to claim 10,
wherein the analysis unit
predicts distribution of tasks that are to occur in future from past performance, and analyzes the optimization problem related to task execution such that the objective function in a case where a predicted task is added to the already scheduled task is maximized or minimized.

12. The information processing apparatus according to claim 1,
wherein the setting unit
sets the group based on a quorum.

13. The information processing apparatus according to claim 1, being a robot.

14. An information processing method executed by an information processing apparatus, which is one of nodes in a network system including a plurality of the nodes, comprising:
analyzing each of possibility of securing a resource shared by nodes, availability of each of the nodes, and an optimization problem related to task execution; and
setting a group of nodes participating in agreement formation in the network system based on at least one of analysis results in the analyzing.

15. A program causing a computer, which is one of nodes in a network system including a plurality of the nodes, to:
analyze each of possibility of securing a resource shared by nodes, availability of each of the nodes, and an optimization problem related to task execution; and
set a group of nodes participating in agreement formation in the network system based on at least one of analysis results in the analyzing.
